(19) United States
(12) Patent Application Publication
(10) Pub. No.: US 2005/0091399 A1
(43) Pub. Date: Apr. 28, 2005

(54) Resource-aware adaptive multicasting in a shared proxy overlay network

(76) Inventors: Kasim Selcuk Candan, Tempe, AZ (US); Yusuf Akca, Santa Clara, CA (US); Wen-Syan Li, Fremont, CA (US)

Correspondence Address: DLA PIPER RUDNICK GRAY CARY US, LLP, 2000 UNIVERSITY AVENUE, E. PALO ALTO, CA, 94303-2248, US

(21) Appl. No.: 10/676,444

(22) Filed: Sep. 30, 2003

(51) Int. Cl. G06F 15/173

(52) U.S. Cl. 709/238; 709/240; 709/243

(57) ABSTRACT

An network of proxy servers overlaying a wide area network that comprises a plurality of autonomous systems establishes a hierarchial multicast tree overlay network structure for providing streaming live media from media sources to end users. The tree structure is constructed and maintained by peer-to-peer negotiations between proxy servers that identify proxy servers and data paths that optimize utilization of network resources based upon minimizing costs as a function of loadings. The proxy servers maintain information about the status of neighboring proxy servers, and exchange messages to redirect join requests to more suitable proxies, to redistribute portions of their own loads when they are overutilized, and to consolidate loads when they are underutilized.

### BACKGROUND OF THE INVENTION

This invention relates generally to peer-to-peer overlay networks of proxy servers, and more particularly to proxy overlay networks for streaming live media.

Wide area networks, such as the Internet, that are used for multicasting streaming media from a plurality of sources to a plurality of end users comprise a network of multiple autonomous systems (“ASs”) and an overlay network of proxy servers (“proxies”) that function as nodes for multicasting the streaming media. Each AS may host one or more proxy servers which can direct streaming traffic across the borders of the AS to a neighboring AS. Proxy servers may multiplex media streams received from other proxy servers or from media servers, and provide the multiplexed streams to other proxies or to end users. Each AS has a multiplexing capacity which is limited by the processing power of its proxy servers and the local bandwidth limitations of paths between ASs. An AS can also “tunnel” a stream, i.e., pass the stream, from a neighboring AS to another AS. While this uses bandwidth resources at the peering points (communications paths that cross borders between ASs), it does not affect the multiplexing capacity of the AS, which depends primarily on local resources.

Known multicasting overlay networks create multicast tree structures using peers of proxies that independently enter and leave the network. These tree structures are typically created in known systems so as to minimize the latency between end users and a corresponding media source. This approach, however, does not utilize resource capacity in the most efficient or least costly way. For example, an overlay network typically has to support multiple simultaneous media streams, each with a different source and user population. Known approaches, however, do not appropriately consider multiple media sources and user populations and do not effectively share the resources of the overlay network in an optimum manner.

Additionally, another problem is that known overlay networks do not minimize operational costs or use resources most effectively. Each AS is an independent entity (such as an Internet service provider, for example), which has to be compensated monetarily for the resources of the AS consumed by the media streams it delivers. Consequently, each AS on which an overlay network operates will charge the overlay network for the bandwidth streamed through it. Additionally, ASs are connected to each other through peering points, each of which has a maximum bandwidth capacity. Any stream that crosses an AS boundary utilizes a portion of the limited capacity of the path as well as of the overlay network. Purchasing, deploying and maintaining a proxy server in an AS is costly, and present overlay networks find it difficult to balance the conflicting goals of minimizing physical resources to minimize costs while avoiding overutilization of network resources and peering points in the face of varying workloads.

There is a need for method and systems which avoid the foregoing problems of known shared proxy overlay networks for multicasting media streams by affording better utilization of resources and reduced costs while accommodating the needs of users requesting access to streaming media, and it is to these ends that the present invention is directed.

### SUMMARY OF THE INVENTION

The invention solves the foregoing and other problems of known proxy overlay networks for streaming media by affording an overlay proxy server network structure that uses proxy-to-proxy negotiations for establishing and optimizing utilization of resources. Proxy servers communicate to establish or restructure the network structure to optimize utilization of network resources through request redirections, load redistributions and load consolidations across autonomous systems. Restructuring may occur dynamically as conditions change.

A proxy that receives a join request for access may redirect the request to a more suitable proxy that can more efficiently handle the request. Additionally, a proxy which is overloaded may initiate redistribution to send part of its load to a different proxy, and an underutilized proxy may send part of its load to another proxy where it is combined or consolidated with other loads. The invention employs an information exchange messaging protocol the maintains information as to the status of other network resources. This facilitates adaptively shifting loads and responding to requests by changing network structure to afford optimum use of resources. The invention avoids overutilized or underutilized resources, and minimizes end-to-end delays and overall operational costs.

In one aspect, the invention provides a method of distributing streaming data in a wide area network which comprises an overlay network of proxy servers on autonomous systems in which proxy servers communicate with neighboring proxy servers to identify proxy servers and data paths that optimize utilization of network resources based upon a predetermined relationship that characterizes tensions of the proxy servers and data paths. The proxy servers communicate by exchanging messages; and, in responds to the messages, activate neighboring proxy servers to form a portion of a hierarchial overlay network structure as applies the data stream to a requester.

In another aspect, the invention provides a method which may activate, in response to communicating between proxy servers, first proxy servers of the overlay network to form a first hierarchial overlay network structure of proxy servers to establish a plurality of data paths through the overlay network to distribute a first data stream from a first data source to a first group of requesters. The method further activates in response to the communicating second proxy servers to form a second hierarchial structure to establish another plurality of data paths through the overlay network to distribute a second data stream from a second data source to a group of requestors. The first and second hierarchial structures may share one or more of the first and second proxy servers.

In yet another aspect, the invention provides a method of distributing streaming data in a wide area network that optimizes utilization of network resources based upon a predetermined relationship that characterizes the tensions of the proxy servers and data paths by exchanging messages with neighboring proxy servers and utilizing stored information concerning proxy servers status to activate a proxy server to form an optimum data path for supplying a data stream to a requester.

### BRIEF DESCRIPTION OF THE DRAWINGS

FIG. 1 is a diagrammatic view illustrating a multicasting overlay network in accordance wit the invention, showing the sharing of proxy resources by two media sources;

FIG. 2 is a diagrammatic view illustrating two autonomous systems (ASs), each containing a plurality of proxy servers, and being connected at a peering point;

FIG. 3 comprising FIGS. 3(a)-(b) illustrates two alternative resource tension graphs which may be utilized by the invention for creating and maintaining multicast tree structures;

FIG. 4 comprising FIGS. 4(a)-(b) illustrates redirection of a request;

FIG. 5 comprising FIGS. 5(a)-(b) illustrates load redistribution to avoid overutilization of a resource;

FIG. 6 comprising FIGS. 6(a)-(b) illustrates load consolidation to avoid underutilization of a resource;

FIG. 7 is a flow chart illustrating a process performed by a proxy in response to a join request;

FIG. 8 comprising FIGS. 8(a)-(b) illustrate, respectively, request redirection and tunneling processes;

FIG. 9 comprising FIGS. 9(a)-(c) illustrate an expansion process of a neighborhood through redirection;

FIG. 10 illustrates a process of selecting alternative parents using cost estimation;

FIG. 11 comprising FIGS. 11(a)-(b) illustrate loop avoidance in join requests; and

FIG. 12 comprising FIGS. 12(a)-(c) illustrate loop avoidance in redistribution.

### DESCRIPTION OF PREFERRED EMBODIMENTS

The invention is particularly adapted for use in a shared proxy overlay network employed for simultaneous multicasting of live media streams and will be described in that context. It will become apparent, however, that this is illustrative of only one utility of the invention.

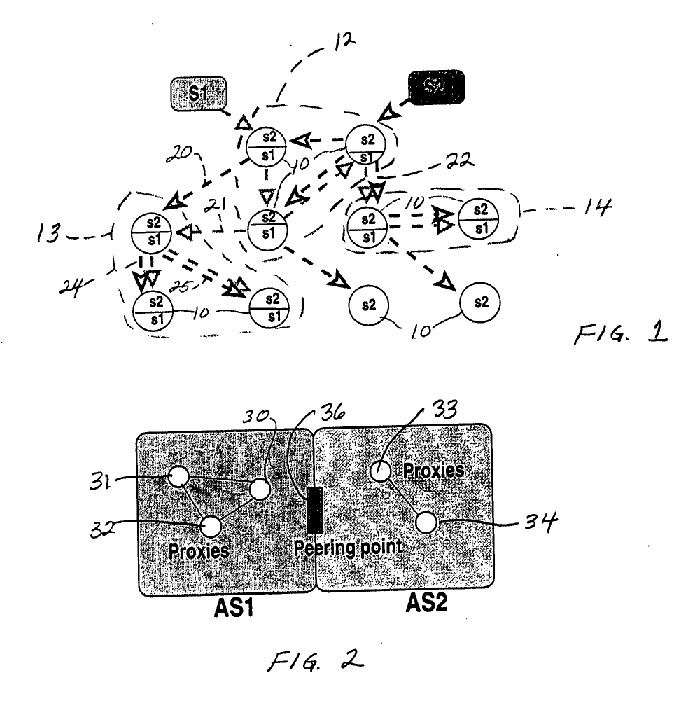

FIG. 1 illustrates a multicasting overlay network in accordance with the invention in which overlay network proxy resources may be shared to provide access to media streams from different media sources. As shown, the overlay network may comprise a plurality of proxy servers 10 which may be overlaid on a plurality of autonomous systems (ASs) 12-14 to provide access to media streams from media sources S1 and S2. The dotted lines from the media sources and between the proxy servers represent communications paths or links between the overlay network resources for the two media streams. The designations “S1” and “S2” within the circles in the figure, which represent proxy servers, indicate that a proxy server is a shared resource that provides access to both streams by using a portion of its capacity for each stream. The positions of the horizontal lines across the circles, which indicate the proxy servers 10, represent the portion of a capacity of the proxy server utilized by each media stream. As is also shown in the figure, the proxy servers are linked or connected by paths so as to form separate hierarchical multicast tree structures with respect to each media stream. The proxy servers may be located within each AS upon agreement with the operators of the AS. Each AS on which the overlay network operates will typically charge for the bandwidth resources used for the media streamed through it, and the overlay network will consequently incur a corresponding monetary cost. Thus, for example, the streams 20 and 21 from AS 12 to AS 13 will be through a peering point (an inter-AS data path for streaming media as will be described) having a particular bandwidth capacity, and charges will be incurred based upon the amount of the capacity of the peering point used. Typically, the paths between proxy servers within an AS, such as paths 24 and 25 within AS 13, do not incur charges based upon the resources used (once a basic subscription fee is paid by a user) and, therefore, are substantially free. Therefore, it is advantageous to minimize the traffic that flows across AS boundaries to minimize costs and the invention takes this into consideration, in a manner that will be described, in constructing and maintaining a multicast tree structure.

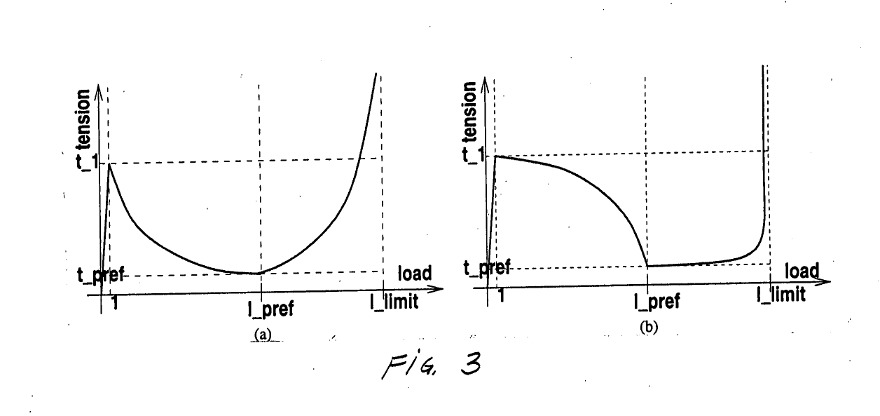

FIG. 2 illustrates the structure of two autonomous systems and their peering point connection in more detail. As shown, autonomous systems AS1 and AS2 may contain a plurality of interconnected proxies. As shown, AS1 may have proxies 30-32 and AS2 may have proxies 33-34. The two ASs are connected at their boundary by a peering point 36. The peering point comprises a communications path or link between the two ASs which has a predetermined maximum bandwidth capacity that may be established by service agreements between the operators of each AS. This may be less than the actual maximum bandwidth capacity of the hardware resources utilized for the peering point. Consequently, any media stream that crosses the peering point boundary 36 between the ASs utilizes the limited resource and incurs a corresponding charge. As noted earlier, the paths between proxies within an AS, such as indicated by the lines between proxies 30-32 in AS1, may be free. Therefore, it is desirable to minimize the amount of traffic that flows across AS boundaries in constructing or maintaining the multicast tree, and the invention takes this cost into consideration in a manner which will be described.

Each AS in a physical wideband network may contain none or one or more proxy servers. For the purposes of explanation in this specification, all proxy servers within a given AS will be treated as a single proxy server. The role of a proxy server is to multiplex streams it receives parent sources, such as from media sources or other proxies, and to serve the multiplexed streams to media requesters, such as other proxies or end users. Each AS has a multiplexing capacity that is limited by the processing power of the available proxy servers, or due to local bandwidth limitations. An AS may also serve as a “tunnel” passing a stream from one neighboring AS to another. (This will be explained further below in connection with FIG. 8(b).) Although tunneling uses bandwidth resources at the peering points, it may not impact multiplexing capacity of the AS, which depends primarily on local resources.

In addition to the utilization costs, both monetary and in terms of network resources such as capacity, bandwidth, etc., purchasing, deploying and maintaining a proxy server in an AS is costly. Therefore, it is desirable for the overlay network to optimize the use of network resources and minimize the number of proxy servers used to handle a given workload. The invention takes these factors into consideration in establishing and maintaining the tree structures, and in servicing requests for access to streaming media. It does this in by the paths it establishes through a peer-to-peer negotiation process to service requests, as well as in allocating and using system resources. It is desirable to optimize the utilization of resources so that they are neither underutilized nor overutilized. Underutilization of resources is undesirable for cost reasons; similarly, overutilization of resources is undesirable for performance reasons. Overutilization can lead to network congestion, rejection of user requests for access, reduced stream quality, and vulnerability to sudden changes in system conditions, among other undesirable consequences. The invention addresses these issues by constructing and maintaining the multicast tree structures according to predetermined relationships between the load on system resources and the corresponding “tension” as a measure of cost for that load. The invention may employ different relationships for this purpose.

FIGS. 3(a) and (b) illustrate examples of different alternative tension versus load relationships which the invention may employ. These relationships are illustrated in the form of graphs that represent the tension as a measure of the different costs (both monetary and system resource costs) associated with utilization of proxy resources. Similar tension relationships may also be established for bandwidth resources. The relationships shown in FIGS. 3(a) and (b) show the cost associated with deviating from a preferred proxy resource utilization. They show that tension is minimized at a preferred or optimum level (t_{pref}) when a proxy resource is used at a preferred load (l_{pref}), and that tension increases sharply when its load is approaches maximum capacity (lₗᵢₘᵢₜ). Tension also increases to a local maximum (tₗ) as the utilization (load) of the proxy drops below the preferred level, and tension is zero when the resource is not utilized at all.

As shown in FIG. 3(a), tension decreases rather quickly from the local maximum (tₗ) at a utilization level of 1 and flattens as utilization increases toward the preferred loading (l_{pref}) at which it is minimum (t_{pref}). As load continues to increase beyond the preferred level, tension again rapidly increases as the loading approaches the limit (lₗᵢₘᵢₜ) of the proxy server. The rapid increase in tension above the preferred loading in FIG. 3(a) may represent in part, for example, the risks associated with overutilization of the resource, such as the previously mentioned congestion, rejection of user requests, reduced quality and vulnerability to system changes.

A different operating relationship that may be employed is shown in FIG. 3(b). There, tension is flatter and decreases more slowly as loading increases from an initial loading, and then decreases rapidly as utilization approaches the preferred utilization level (l_{pref}). Thereafter, tension remains low above the preferred level as the load increases toward the limit of the resource (lₗᵢₘᵢₜ). Consequently, the relationship illustrated in FIG. 3(b) indicates a preference for selecting proxies whose utilization is already close to the preferred level when choosing a proxy to service a new request, rather than selecting proxies that are more lightly loaded. FIG. 3(b), moreover, reflects a policy that prefers selecting proxies that have loadings somewhat above the preferred level to satisfy new requests, and indicates a corresponding lack of concern for risks associated with overutilization. Both relationships shown in the figures show high tension is associated with using resources that are very lightly loaded; tₗ is the cost or tension of activating a new proxy in the network.

For a given set of proxies, a particular AS level network structure, a set of media sources, and particular loads accessing media, the invention creates multicast tree structures that optimize network resources and tension. More particularly, the invention creates structures such that resources are neither overutilized nor underutilized, and in which the overall operational cost is minimized. The end-to-end delays may also be small. It does this using an overlay network structure that employs proxy-to-proxy (peer-to-peer) negotiations for establishing and maintaining optimum resource utilization through redirection of requests, load redistributions, and load consolidations across ASs. As will be described in more detail below, when a proxy receives a join request for access to a media stream, the proxy may either admit (accept) the request, deny the request, or redirect the request to a more suitable proxy in its neighborhood. An overloaded resource may initiate a redistribution process in which it transfers part of its load to a different proxy. Similarly, an underutilized resource may request consolidation in which some load from an underloaded server may be transferred to another server. The invention provides protocols, as will be described, that enables the overlay network to scale and adapt itself as sources and requesters come and go and as multicast paths are created and destroyed. Unlike IP-multicasting-based approaches, the invention considers and integrates AS-level service agreements into its network structuring processes since it takes these into consideration as part of tension. Moreover, the invention maintains an awareness of the overall status of the network and seeks to optimize utilization of the network and proxy resources, along with an average delay, within an integrated framework. Unlike static overlay-network based approaches, the invention dynamically adapts to varying data, network and user load conditions in a distributed peer-to-peer manner to optimize the utilization and tension of network resources. The manner in which the invention accomplishes this will be described in more detail below.

Briefly summarized, the invention seeks to deliver media streams to end users using as few network resources as possible while preventing resource congestions and reductions in quality of service. It does this by deploying application-level hierarchical multicasting structures through its proxy servers, and so that peer-to-peer and overall network tension is minimized. The overall tension which is minimized comprises the sum of the tensions of peering points (btensionⱼ) in the network, plus the sum of the proxy tensions (ptensionⱼ) in the network. Significantly, the invention optimizes tension using a decentralized decision-making and adaptability approach. Decisions on establishing connections and loading are made through peer-to-peer negotiations between proxies. Moreover, as sources and requesters join and leave the overlay network, operating conditions are constantly changing. Since there is typically a significant cost associated with globally changing existing paths, the invention adapts to changes to the extent possible with local modifications.

The invention may employ several different complementary protocols for effecting an optimized overlay network multicast tree structure. These protocols comprise a media streaming protocol, an information exchange protocol, and a multicast management protocol. The media streaming protocol may be selected according to the type of media delivered through the media streaming overlay network of the invention. It specifies how media is transmitted from a source to an end user through a chain of proxies. Suitable protocols that may be used include, for example, Real Time Streaming Protocol (RTSP), Real Time Control Protocol (RTCP), and transport level protocols such as Real Time Transport Protocol (RTP). Other protocols may also be employed.

The information exchange protocol may comprise any suitable protocol by which a proxy communicates with other proxies and collects information about its environment and media sources. Table 1 (below) indicates some of the information which a proxy may collect from its neighbors and from the sources by communicating and exchanging status information with other proxies. Communication may be performed periodically, on a regular or irregular basis, or a proxy may initiate communications upon the occurrence of an event, such as a request for access. The regular information exchange helps proxies maintain information on network resource status, and identify when a connection or path between two proxies is interrupted. It may also declare a link failed when the quality of service decreases to an unacceptable threshold even though control messages may travel without problem across the link. Communication between proxies may be handled by a network monitoring process run on each proxy. In addition to periodic information exchange, each proxy may also attach a current list of its values to messages it exchanges with its neighbors, or explicitly request new information when it detects a change in status, as, for example, due to a failure or insertion of new sources.

TABLE 1
Information Collected and Stored by Proxy pᵢ

| Information | Meaning |
|---|---|
| Nᵢ | the list of proxies that are neighbors of pᵢ. |
| bloadₖ | the current load and the tension relationship, respectively, |
| btensionₖ | of each path, eₖ, from pᵢ to its neighbors |
| ploadⱼ | the current load and the tension relationship, respectively, |
| ptensionⱼ | of each proxy pⱼ in its neighborhood |
| minbcostᵢⱼ | the minimum cost of sending a stream from a source sⱼ to |
| | proxy pᵢ |

In Table T1, a “neighbor” proxy refers to a proxy that is logically connected. Initially, it may comprise physical neighbors, i.e., proxies in an AS connected by a path to the AS of proxy pᵢ is a member. However, as load increases, the neighbor members may extend to include proxies that are not immediate neighbors.

Although most of the information in Table T1 requires knowledge about only the immediate neighborhood of a proxy, estimating minbcost_{i,j}, the minimum cost of send a stream from source sⱼ to proxy pᵢ based upon a current network tension and proxy utilization, requires more information on the multicast tree structure than that involving immediate neighbors. This information may be obtained by estimating source-to-proxy distances, either through the exchange of messages between proxies, or by assuming the shortest distance based on an assumption that the network and proxies are used at their preferred levels. This assumption is advantageous in that it eliminates the need for constant information exchange and instead requires communications only with respect to significant changes in network structure, such as the addition or removal of a proxy or a network edge.

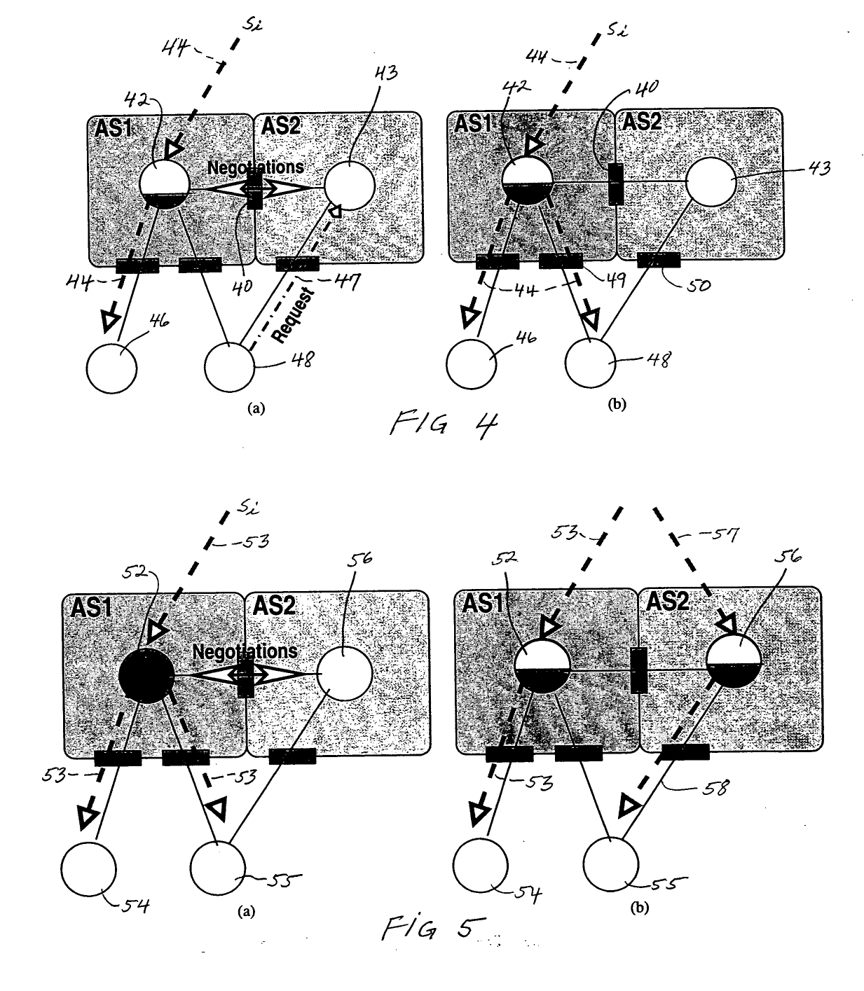

The multicast management protocol is the protocol which embodies the peer-to-peer decision-making processes used for creating and managing the multicast tree structure. It also updates the structure as conditions such as load and request characteristics in the overlay network change. This protocol preferable operates in a request-driven manner, i.e., multicast tree structures are generated or changed as requests for access arrive or other conditions change. When a new source is inserted into the network, the only required initialization process is to make proxies aware of the new source. This may be achieved by a central lookup registry, which publishes a list of sources to the proxies, or, preferably, by allowing proxies to discover sources through the peer-to-peer information exchange protocol described above. Otherwise, the operation of each proxy is driven by join requests from other proxies, stop requests from other proxies, and messages that initiate changes in the multicast tree structures. The join and drop requests may result in load redirections, redistributions and consolidations in order to avoid overutilization or underutilization of a resource. FIGS. 4-6 illustrate, respectively, request redirection, load redistribution, and load consolidation processes.

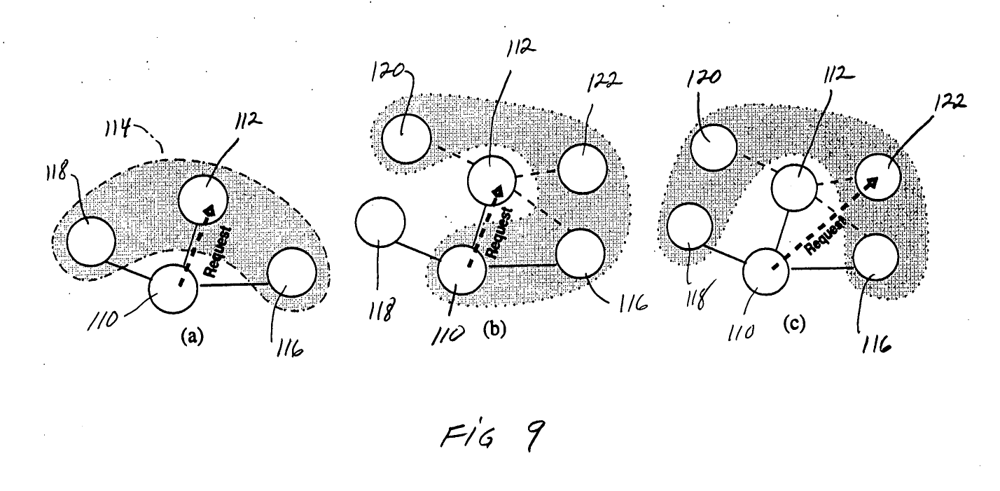

FIG. 4 illustrates two neighboring autonomous systems AS1 and AS2 having a common peering point or boundary 40. AS1 includes a proxy 42 receiving a media stream 44 from a corresponding source, and provides stream 44 to a child proxy 46. Stream 44 may consume approximately one-fourth of the capacity of proxy 42, for example, as indicated by the horizontal line and darkened lower one-quarter portion of the circle representing proxy 42 in FIG. 4(a). As is also shown in FIG. 4(a), AS2 may have a proxy 43 which receives a request 47 from a proxy 48 for access to media stream 44. Since proxy 43 is not receiving media stream 44, it seeks a more suitable proxy to serve the request, and enters negotiations via peering point 40 with proxy 42. Proxy 42 has excess capacity, and assuming the cost of supplying media stream 44 to proxy 48 would be less if supplied by proxy 42 rather than proxy 43, proxy 42 may admit the request from proxy 48 and begin supplying stream 44 to proxy 48. As indicated in FIG. 4(b), this may increase the load on proxy 42 to approximately one-half of its capacity. Moreover, as shown in FIG. 4(b), proxy 42 supplies stream 44 directly to proxy 48 via peering point 49. It is assumed the cost would be less than supplying the stream to first to proxy 43 via peering point 40 and then incurring an additional cost as proxy 43 supplies the stream to 48 via another peering point 50. This is determined by the peer-to-peer negotiations between proxies which seeks the minimum cost paths. The request redirection process illustrated in FIG. 4 will be described more fully in connection with the description of FIG. 7.

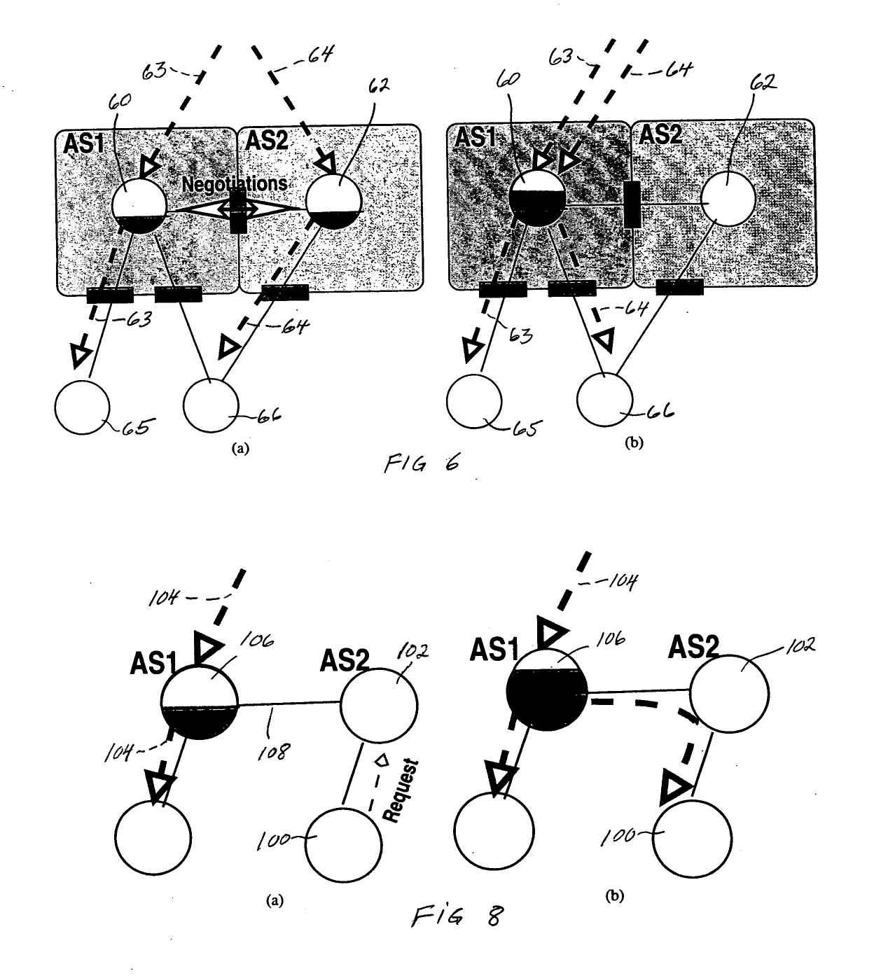

FIG. 5 illustrates load redistribution to avoid overutilization of a proxy. As shown in FIG. 5(a), a proxy 52 in AS1 may be receiving streaming media 53 and supplying the streaming media to proxies 54 and 55. As indicated in FIG. 5(a), proxy 52 may be at substantially full capacity (as indicated by the completely darkened circle in the figure representing proxy 52). Therefore, it is operating at or close to its load limit, is being overutilized, and incurring an associated high tension, assuming the relationships indicated in FIGS. 3(a)-(b). Accordingly, proxy 52 will seek a suitable proxy in order to redistribute a portion of its load. As shown, it may enter negotiations with a neighboring proxy 56 to accept a portion of media stream 53. These negotiations will involve a comparison of costs or tension associated with transferring part of the load on proxy 52 to proxy 56. Since proxy 56 is unloaded and transferring the load incurred in supplying media stream 53 to proxy 55 may be assumed to take approximately one-half of the capacity of proxy 56 (see FIG. 5(b)) this would result in proxies 52 and 56 operating at approximately their preferred load and incurring a corresponding preferred tension, as illustrated in FIG. 3. Accordingly, proxy 56 establishes a connection to the source of media stream 53 and begins supplying the media stream to proxy 55 via a path 58.

Load redistribution to avoid overutilization, as shown in FIG. 5, can result in more optimum utilization of network resources by reducing the tension on both proxies and paths.

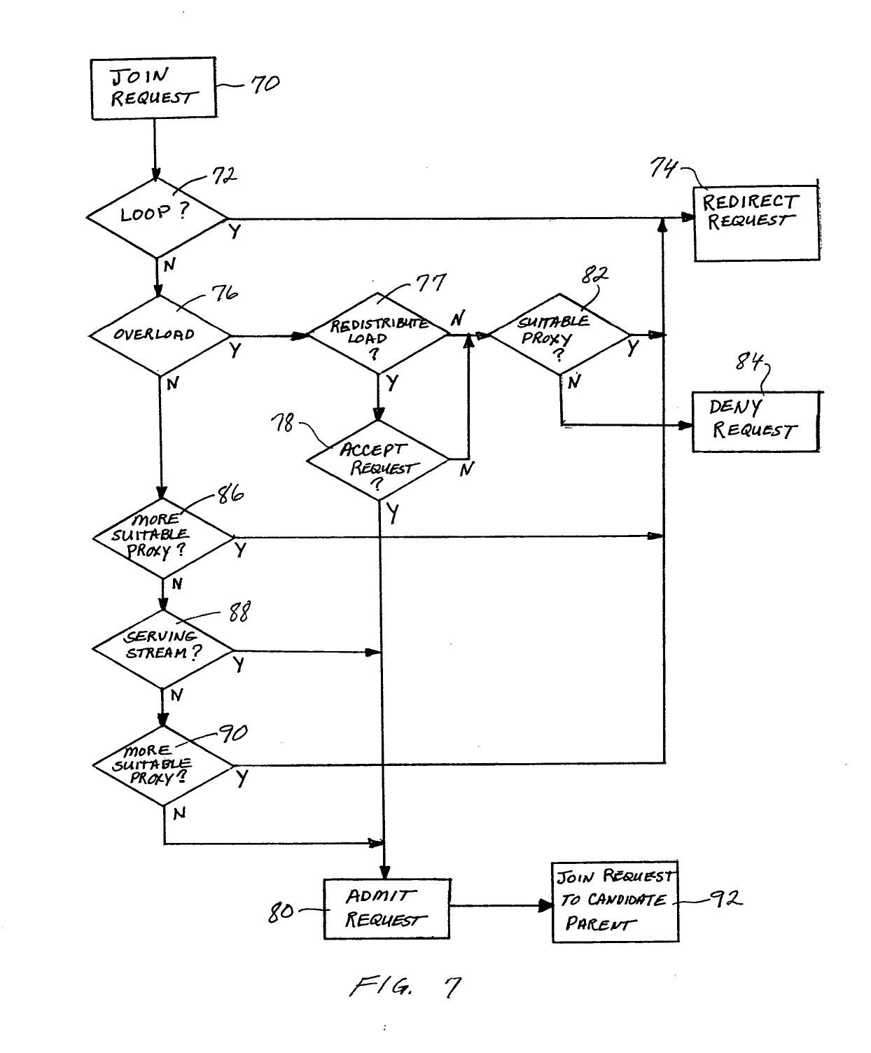

FIG. 6 illustrates a load consolidation process to avoid underutilization of a proxy. Referring to FIG. 6(a), proxies 60 and 62 in neighboring autonomous systems AS1 and AS2 may be receiving media streams 63, 64, respectively, which may be the same or different media streams. Proxy 60 may be supplying media stream 63 to proxy 65 and proxy 62 may be supplying media stream 64 to proxy 66, as indicated in FIG. 6(a). As also indicated in the figures, proxies 60 and 62 may be lightly loaded and, therefore, well below their preferred loads (l_{pref}). Accordingly, as shown in FIG. 3, proxies 60 and 62 may both be incurring a relatively high tension, which they will discover through the information exchange protocol described previously. Thus, the two proxies may enter negotiations to determine the cost of consolidating their loads. Assuming that consolidating both loads in proxy 60, as shown in FIG. 6(b), results in proxy 60 being loaded at approximately one-half of its capacity (assumed to be at its preferred load (l_{pref})), proxy 62 transfers its load to proxy 60, and proxy 60 begins to supply streaming media 64 to proxy 66 as indicated in FIG. 6(b). Thus, by changing the multicast structure to consolidate loads, reduced tension and more optimum use of resources is afforded.

The restructuring processes of the multicast tree structure illustrated in FIGS. 4-6 provide an overview of the decentralized peer-to-peer negotiation processes of the invention which afford optimum utilization of network resources. Each of these will be described in more detail below.

FIG. 7 is a flow chart of the process performed by a proxy in response to a join request by a requester, such as described above in connection with FIG. 4. As shown, upon a proxy pᵢ receiving a join request 70 from either a requester, i.e., a user or another proxy, for access to a media stream multicast by a source sⱼ, the proxy has to determine whether it should admit the request or forward the request to another more suitable proxy. Proxy pᵢ first checks, at 72, to determine whether accepting the request 70 will cause a loop in the tree structure. Proxy pᵢ does this using the information exchange protocol previously described and the information collected and maintained by the proxy. If a loop is detected, the request may be redirected to another proxy pⱼ (at 74), as previously described, for example, in connection with FIG. 4. If the request does not cause a loop, the proxy next checks, at 76, whether it has capacity to accept the request or whether accepting the request will possibly produce an overload. If an overload is possible, the proxy checks (at 77) whether redistribution of a part of its existing load to other proxy servers will enable it to accept the request. If so, the proxy redistributes a part of its load (at 78) and admits the request (at 80). If redistribution is not possible, the proxy then seeks a suitable proxy (at 82) in the neighborhood to serve the join request. If it locates one, the proxy may then redirect the request to that proxy (at 74). Otherwise, it denies the request at 84.

Even if proxy pᵢ has capacity to accept the request without the possibility of being overloaded, it nevertheless preferably checks (at 86) to determine whether there is a more suitable proxy pⱼ in the neighborhood to serve the join request. If so, it then redirects the request to proxy pⱼ (at 74). Proxy pᵢ checks (at 88) to determine whether it is already serving the stream. If so, then it may admit the request (at 80). If the proxy is not serving the stream, it next checks (at 90) for a more suitable neighbor, and redirects the request (at 74) to the neighbor. Otherwise, the proxy admits the request (at 80) and then sends a join request to a candidate parent (at 92) determined based upon network costs and tensions.

In step 76 of the process, the proxy first checked to determine whether accepting the request would result in a possible overload. Preferably, the invention does not define overload in absolute terms. Rather, the invention preferably defines an overload as a condition where redistributing a fraction (θ) of its load to some other neighboring proxy server, pₕ, will be beneficial to the overall operation of the network, in terms of reduced tension, i.e., whether:
t_{—}reduction_{—}at_{—}i>(1+γ_{d})×t_{—}increase_{—}at_{—}h
or, stated differently,
ptensionᵢ(ploadᵢ)−ptensionᵢ((1−θ)×ploadᵢ)>(1+γ_{d})×ptensionₕ(θ)×ploadᵢ)
where, 0.0≦γ_{d} and γ_{d} is a threshold factor that may be selected to provide a level at which a load redistribution will be initiated. If this condition is satisfied, redirection or redistribution negotiations, as previously described, may occur between proxies to redistribute and handle loads.

Before admitting a join request for a stream from a source as described in connection with FIG. 7, proxy pᵢ may check to determine whether there is any proxy in its neighborhood better suited to admit this request. Suitability is defined in terms of optimizing tension. The proxy pᵢ may do this check by first calculating a self-cost of admitting the request. If proxy pᵢ is already serving the stream, then the self-cost may be determined as the difference in tension between the new proxy tension if the request is admitted and the current proxy tension. This may be expressed as follows:
self cost=ptensionᵢ(new_{—}plᵢ)−ptensionᵢ(old_{—}plᵢ)

If pᵢ is not serving the stream, the expected network cost (increase in the tension in the network resources) must also be taken into account. In this case, proxy pᵢ may estimate the cost of admitting this request as follows:
self cost=ptensionᵢ(new_{—}pl₁)−ptensionᵢ(old_{—}plᵢ)+minbcost_{i,j}
where minbcost_{i,j} is the cheapest distance based on the current tension values in the network for a path between servers pᵢ and pⱼ. This value is only an estimate of the actual network tension and costs. The request for a particular stream may actually be routed through a more costly route depending on actual resource loads, or routing may cost much less if a multicast tree structure serving the stream is found nearby.

The costs of directing the request to the neighbors pₕ of pᵢ may be estimated as:
costₕ=ptensionₕ(new_{—}plₕ)−ptensionₕ(old_{—}plₕ)+minbcost_{h,j}+btension_{i,h}(new_{—}bl_{i,h})−btension_{i,h}(old_{—}bl_{i,h})
The main difference in this cost estimation from the determination of the self cost is that in addition to estimating the cost for a neighboring proxy, pₕ, pᵢ may also consider the cost associated with acting as a network tunnel for the request in the event that the requesting proxy does not have a direct connection to proxy pₕ.

FIG. 8 illustrates the redirection of a request and the tunneling process. As shown in FIG. 8(a), a requesting proxy 100 that sends a request to a proxy pᵢ 102 in AS2 that is not serving a media stream 104 redirects that request to a neighboring proxy pₕ 106 that is serving media stream 104, as previously described. Here, the requesting proxy 100 does not have a direct connection to proxy 106. In this event, proxy 102, which receives the request also considers the cost associated with acting as a network tunnel for the request. As a tunnel, proxy 102, which has a direct connection 108 to proxy 106, receives media stream 104 and tunnels or passes the media stream to requesting proxy 100. As shown in FIGS. 8(a) and (b), this increases the load on proxy 106, and this is taken into consideration in the above equation in determining the costₕ.

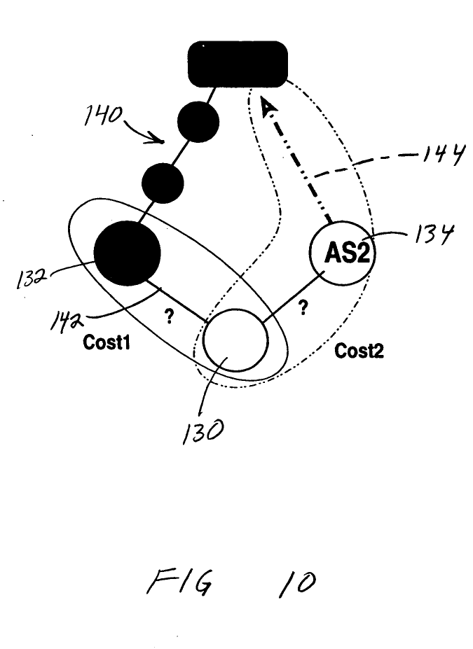

If the proxy originating the request and the neighbor proxy pₕ both have a direct connection to a proxy serving the media stream, then that connection may be used after redirection. Also, in order to facilitate the redirection process, the cost estimation for neighbors in the network is preferably computed frequently by proxies (such as periodically when the information in Table T1 is updated) in anticipation of restructuring of the network. These may be kept in a local table at each proxy, such as Table 1. Once the cost estimates are computed, if the most suitable proxy is not the proxy pᵢ to which the join request was directed, that proxy pᵢ may send a list of candidate proxies and the associated costs which it determined to the requesting proxy along with a redirection message. The requesting proxy may then choose a proxy from the list that optimizes the network and forward a joint request to that proxy. FIG. 9 illustrates the expansion of a neighborhood through redirection.

As shown in FIG. 9(a), a proxy 110 may forward a request to a proxy 112 in its neighborhood 114, which includes proxies 116 and 118. Proxy 112 may be the proxy that was determined to be the most suitable candidate based upon cost estimates described above. As shown in FIG. 9(b), the neighbor proxy 112 to which the original request was directed may choose to redirect the request to one of its neighbors 120, 122, either because of its own load or it knows that one of these neighbors is better suited for the request. Because of information exchanged between the proxies, the original proxy 110 now has a wider view of the neighborhood and can send the request to the most suitable proxy, e.g., 122, as shown in FIG. 9(c). Thus, the peer-to-peer information exchange protocol enables proxies to become aware of the status of network resources and to adaptively access those resources in the most cost effective and optimum manner.

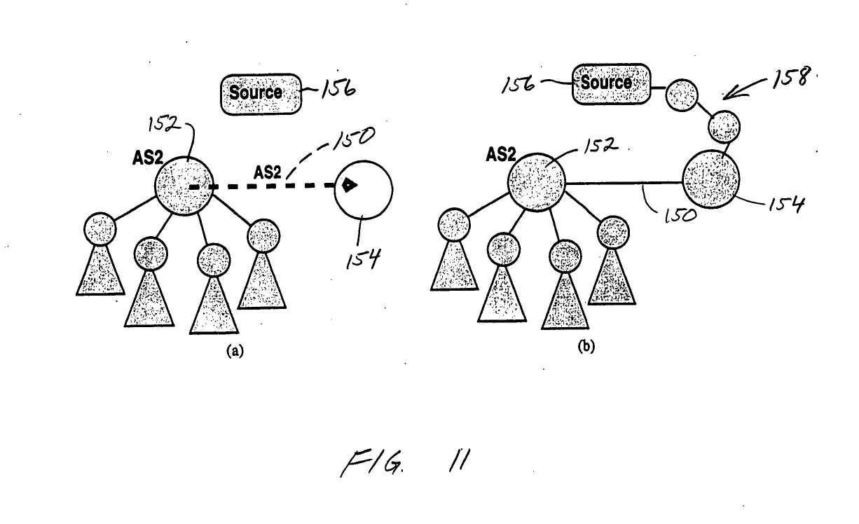

If a proxy pᵢ decides to admit a request, and if the request is for a stream that is not already served by this proxy, then pᵢ has to find a way to join the multicast tree structure that serves the stream. To do this, it evaluates its neighbors and selects the most suitable one to which to send a join request. As shown in FIG. 10, a proxy pᵢ 130 may consider its neighbors 132, 134 in AS1 and AS2, respectively, when choosing the next proxy. For those neighbors such as pₗ 132 that are already on the required multicast tree structure 140, pᵢ may estimate the cost of connection as:
costₗ=ptensionₗ(new_{—}plₗ)−ptensionᵢ(old_{—}plₗ)+btensionᵢₗ(new_{—}bl_{i,l})−btensionᵢₗ(old_{—}bl_{i,l})
That is, proxy pᵢ, 130, accounts for the increased tension at the new parent (pₗ) 132 as well as the increased tension on the network connection 142 between itself and parent 132. If a candidate parent proxy, 134, for example, is not serving the stream, proxy pᵢ 130 also accounts for the fact that the candidate parent 134 will need to establish a route 144 to the source, and determines the cost as:
costₗ=ptension₁(new_{—}plₗ)−ptensionₗ(old_{—}plₗ)+btension_{i,l}(new_{—}bl_{i,l})−btension_{i,l}(old_{—}bl_{i,l})+minbcost_{i,j}.

After the estimates are computed for all neighbors (132, 134), proxy pᵢ may choose the most suitable proxy and forward the request to that proxy. In order to prevent redirection loops, proxy pᵢ preferably maintains a list of the set of proxies to which it has already redirected requests. Once the neighbor proxy receives the join request, it can either deny, redirect, or admit the request, as described above.

A proxy pᵢ that has received a join request may either admit, deny, or redirect the request, as previously described, and may send back to the sending proxy a corresponding admit, deny or redirection message. Unless the request is admitted, the sending proxy has to find an alternative proxy to join the request. As described above, redirection messages preferably carry information about potential candidate proxies and their associated costs. The sending proxy may merge this information with the information it already has about its neighborhood and send the request to the most suitable candidate of which it is currently aware. Unless a limit on redirection requests is established, a request may be redirected multiple times. Therefore, preferably, a limit, redirₗᵢₘᵢₜ, is placed on the number of times each request can be redirected. Once the redirection limit is reached, if the proxy receiving the request fails to join to the stream, it may send a deny message downstream to the sending proxy waiting for the establishment of the connection. The downstream proxy may then initiate its own deny-message handling routines and take additional action, such as sending join requests to other proxies.

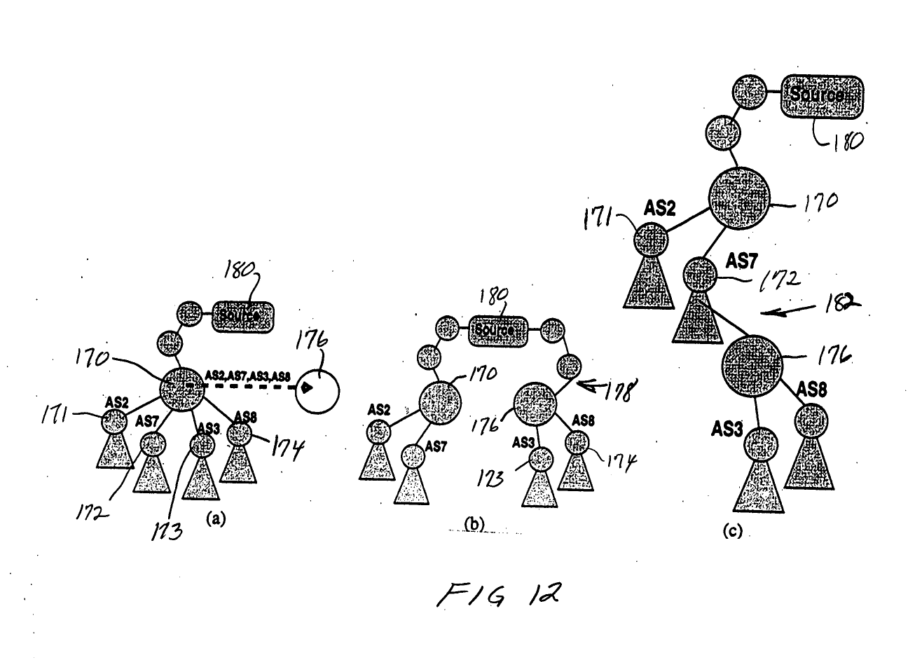

A join request may originate either from an edge proxy or from a proxy that is serving other proxies during establishment of the multicast tree structure. In the latter case, it is desirable to employ appropriate mechanisms to eliminate routing loops. A preferred way of accomplishing this in accordance with the invention is to annotate each join request with the name of the AS where the request originates. This is illustrated in FIG. 11(a) where a request 150 from a proxy 152 in AS2 is labeled with its source (AS2) when it is sent to a receiving proxy 154. If the receiving proxy already has a path to the source 156 of the stream, it only has to verify that the list it maintains of its parents does not include AS2 where the join request originated. If there is not already an established path to the source, then the receiving proxy may take steps to ensure that the path 158 (see FIG. 11(b)) that it will create to the source does not contain AS2. To achieve this, each join request is also preferably annotated with the list of downstream proxies waiting for the establishment of a path to the source. Consequently, a proxy receiving a request will be able to easily check whether admitting the request will cause a loop.

When a proxy receives a stop request from a user or from another proxy for access to the media stream multicast at a source, it may simply drop the requesting proxy from the multicast tree structure and makes the corresponding resources available for future requests. If there are no other child proxies consuming a stream served by the proxy, it may also sends a stop request to the corresponding parent for that stream so that it can release all corresponding resources for other use.

One of the scalability mechanisms used by the proxies of the invention is redistribution. When proxy pᵢ detects any change in its neighborhood (for example, as a result of the update messages it exchanges with its neighbors), such as a proxy becoming available or a configuration change, the proxy may check whether if it is overloaded or underloaded relative to its neighbors. Overload may be defined, as previously described, as a condition where the reduction in tension resulting from redistribution of a stream from proxy pᵢ is greater than a predetermined increase in tension by redistribution of the stream to a neighbor proxy pₕ as determined by a threshold factor. This may be expressed as:
t_{—}reduction_{—}at_{—}i>(1+γ_{d})t_{—}increase_{—}at_{—}h
Here, γ_{d} is a threshold factor selected to have a value to prevent small gains in tension reduction from causing potentially costly redistributions. If proxy pₕ is under-utilized, redistribution can also decrease the tension at pₕ benefiting both of the involved proxies. If proxy pᵢ notices that this trigger condition is true for at least one of the streams, then it may initiate a redistribution process seeking to rebalance the overall tension in the system.

During the redistribution process, a proxy pᵢ seeks proxies in its neighborhood that can take a fraction of its load, e.g., 50% in a preferred embodiment. It may first choose the stream, sⱼ, whose redistribution will bring the highest benefit to the system. Then, for this stream, it may choose a proxy, pₗ, to admit the fraction of the load it seeks to redistribute. The process that proxy pᵢ uses to choose proxy pₗ may be similar to the process described previously for choosing the most suitable proxy to which to redirect a request, except that during the redistribution more than one connection may be redirected simultaneously. Hence, the loads that are used for calculating tension changes are based on the fraction of the load being shipped.

Once proxy pᵢ chooses the stream sⱼ and the proxy pₗ to which to redistribute the load, proxy pᵢ sends a message to proxy pₗ requesting it take the required load. In response, proxy pₗ can either admit this load request, deny it, or redirect it. Before admitting the request proxy pₗ may ensure that there is a loop free path to the source as shown in FIG. 12. As in the case of an individual join request, if proxy pₗ chooses to redirect the shipment request, redirection messages are preferably accompanied by the neighborhood list to help proxy pᵢ choose the most suitable proxy in its own and pₗ's neighborhood.

Once a proxy pₗ accepts the shipment, pᵢ starts shipping the load. During this process it preferably locks all resources (hence can not admit new requests). Proxy pᵢ may choose a fraction of its children which are consuming the streams sⱼ and redirect each one of them individually to proxy pₗ. Proxy pₗ may handle these join requests as a group and admit all of them.

Once the processing for stream sⱼ is complete, proxy pᵢ may choose another stream and continue this process until it redirects the required fraction of the load. Once a redirection to a proxy fails (for instance due to link failures), a timeout mechanism may be used to prevent more time being wasted trying to connect to it in the future.

FIG. 12 illustrates the redistribution process and the avoidance of loops. As shown in FIG. 12(a), a requesting proxy server 170 may send a list of the immediate children proxies 171-174 in autonomous systems AS2, AS7, AS3, and AS8, respectively, to the chosen proxy 176 for redistribution. If proxy 176 is able to establish a path 178 to a source 180 that does not go through any other children, as shown in FIG. 12(b), then the proxy can redirect any set of the children, such as 173-174 to source 180 through path 178. However, if, as shown in FIG. 12(c), a path 182 is created by the proxy 176 that passes through a child, such as 172, then a set of proxies that does not include proxy 172 may be redistributed.

A proxy pᵢ may decide to request consolidation in its neighborhood if it determines that a underloaded condition exists as a result of update messages that it exchanges with its neighbors. In this event, the proxy attempts to consolidate its service with that of its neighbors. Consolidation may be triggered when there is at least one proxy server pₕ in the neighborhood such that if it ships one of its streams to proxy pₕ the reduction in tension is greater than a predetermined factor times the increase in tension which would be produced at proxy pₕ. This may be expressed as follows:
t_{—}reduction_{—}at_{—}i>(1+γ_{c})t_{—}increase_{—}at_{—}h
where γ_{c} is a threshold factor selected to have a value that avoids small gains in tension reduction that may produce potentially costly consolidations. Consequently, the consolidation process may be very similar to the redistribution process described above except that the amount of the load negotiated between proxies and redistributed from one proxy to another is the entire load for each stream instead a portion of the load. Upon consolidation of all streams for proxy pᵢ, the proxy becomes unutilized and may be taken out of the network and reserved for future use.

In spite of apparent similarities between consolidations and redistributions, it is easier to predict when a network needs consolidations than when it needs redistributions. This is because consolidations address a current loading where network resources are underutilized, whereas redistributions seek to ensure available resources for an anticipated future situation.

In the event of a failed connection between a proxy and its parent for a stream it is serving, the proxy may engage in a process to repair the failed connection that is similar to redirection. The proxy may redirect itself to another proxy in the neighborhood based on the network and proxy tensions, as previously described, to substitute for the failed connection. A timeout mechanism may be employed in order to avoid having the failed parent being used for a predetermined period of time, and the proxy may lock all resources so that they may not admit new requests for the failed stream.

From the foregoing, it can be seen that the invention employs different types of tension relationships in creating multicast tree structures. These relationships relate to proxy tension and bandwidth tension of the connections between proxies. Although the relationships relate to different resources, they are somewhat related. First, irrespective of internal resources, a proxy server cannot multiplex more streams than permitted by its outgoing peering points. Although an autonomous system can tunnel streams between other autonomous systems without multiplexing, this still requires the use of peering resources and the capacity of these resources by the multiplexing power of the proxy.

Moreover, the cost of the network may have a significant impact on redirection and redistribution. If redirection through network tunneling is less expensive, it may be preferable to activate proxies close to the edge of the network and use redirections instead of redistributions. This may result in shallow multicast tree structures with long proxy-to-proxy network connections where most edge proxies are connected to proxies that are closer to the source. Similarly, the cost of network links in relation to the cost of activating proxies will have an impact on the use of redistributions, and the cost of creating a new proxy, the cost of redirection, and the depth of the multicast restructure are likewise related and influence the creation of multicast tree structures.

While the foregoing has been with reference to certain preferred embodiments of the invention, it will be appreciated that these embodiments may be changed without departing from the principles and spirit of the invention, the scope of which is defined by the appended claims.

1. A method of distributing streaming data in a wide area network that comprises a plurality of autonomous systems having an overlay network of proxy servers, the method comprising communicating between a proxy server and neighboring proxy servers to identify proxy servers and data paths for providing a data stream to a requester that optimize utilization of network resources based upon a predetermined relationship that characterizes tensions of said proxy servers and data paths, said communicating comprising exchanging messages with said neighboring proxy servers; and activating an identified neighboring proxy server in response to said communicating to form a portion of a hierarchical overlay network structure of interconnected proxy servers that establish optimum data paths through the overlay network for supplying the data stream to said requester.

2. The method of claim 1 further comprising dynamically reconfiguring said hierarchical structure of proxy servers in response to said communicating as conditions change to maintain said optimum utilization of resources.

3. The method of claim 2, wherein said dynamically reconfiguring comprises changing the hierarchical network as loading changes.

4. The method of claim 3, wherein said dynamically reconfiguring comprises consolidating proxy servers to optimize loading on proxy servers as loading decreases.

5. The method of claim 4, wherein said consolidating comprises consolidating the loads at a proxy server to optimize loading upon the loads dropping to a predetermined threshold.

6. The method of claim 2 further comprising sending a consolidate message from a proxy server requesting consolidation of data loads to a neighboring proxy server upon data loads to said requesting proxy server dropping to a predetermined threshold.

7. The method of claim 6, wherein said neighboring proxy server is selected to accept said data loads where consolidation of data loads at said neighboring proxy server would result in optimization of loading at such neighboring proxy server.

8. The method of claim 2, wherein said dynamically reconfiguring comprises redistributing loads from said identified neighboring proxy server to another proxy server when the loading on said identified neighboring proxy servers reaches a predetermined threshold.

9. The method of claim 2 further comprising sending a redistribute message requesting redistribution of data loads from said identified neighboring proxy server to another proxy server upon data loads at said identified neighboring proxy server reaching a predetermined threshold.

10. The method of claim 2, wherein said neighboring proxy server is selected as a candidate to accept said data loads where redistribution of data loads at said neighboring proxy server would optimize loading at such neighboring proxy server.

11. The method of claim 1, wherein said optimum utilization of network resources comprises optimizing network bandwidth.

12. The method of claim 1, wherein said activating comprises activating said proxy servers and paths to minimize tension.

13. The method of claim 1, wherein said predetermined relationship comprises a relationship between tension and load.

14. The method of claim 1, wherein said optimizing comprises activating proxy servers and paths that minimize costs.

15. The method of claim 1, wherein said activating comprises activating proxy servers based upon the loadings of the proxy servers.

16. The method of claim 1, wherein said activating comprises activating proxy servers to reduce latency in the data paths between said proxy servers and said requesters.

17. A method of distributing streaming data in a wide area network that comprises a plurality of autonomous systems having an overlay network of proxy servers, the method comprising communicating between proxy servers to identify selected proxy servers and data paths that optimize utilization of network resources based upon a predetermined relationship that characterizes tensions of said proxy servers and data paths, each proxy server identifying an optimum neighboring proxy server and optimum path to service a requester using said predetermined relationship by exchanging messages with neighboring proxy servers; activating in response to said communicating first proxy servers of the overlay network to form a first hierarchical overlay network structure of proxy servers to establish a plurality of data paths through the overlay network to distribute a first data stream from a first data source to a first group of requesters; and activating in response to said communicating second proxy servers of the overlay network to form a second hierarchical structure of proxy servers to establish another plurality of data paths through the overlay network to distribute a second data stream from a second data source to a second group of requesters; said first and second hierarchical structures sharing one or more of said first and second proxy servers.

18. The method of claim 17 further comprising dynamically reconfiguring said first and second hierarchical structures in response to said communicating as conditions change to maintain said optimum utilization of network resources.

19. The method of claim 18, wherein said dynamically reconfiguring comprises redistributing data loads from one proxy server to another proxy server upon data loads at the first-mentioned proxy server reaching a predetermined threshold.

20. The method of claim 18, wherein said dynamically reconfiguring comprises consolidating data loads from one proxy server to another proxy server upon data loads at the first-mentioned proxy server decreasing to a predetermined threshold.

21. The method of claim 18, wherein said dynamically reconfiguring comprises deactivating one or more proxy servers and consolidating data loads at an active proxy server as requesters decrease.

22. The method of claim 18 further comprising dynamically reconfiguring said first and second hierarchical structures independently of one another as loadings change.

23. The method of claim 17, wherein said activating comprises activating proxy servers to optimize network bandwidth in distributing said data steams.

24. A method of distributing streaming data in a wide area network that comprises a plurality of autonomous systems having an overlay network of proxy servers, the method comprising communicating between proxy servers to identify proxy servers and data paths for providing a data stream to a requester that optimizes utilization of network resources based upon a predetermined relationship that characterizes tensions of said proxy servers and data paths, said communicating comprising exchanging messages with neighboring proxy servers; storing information about said neighboring proxy servers; activating in response to said communicating and storing an identified proxy server to form an optimum data path through the overlay network for supplying the data stream to said requester.

25. The method of claim 24, wherein said communicating comprises periodically exchanging messages with neighboring proxies that contain information regarding status, and communicating messages following status changes.

26. The method of claim 25 further comprising communicating a redistribute message requesting redistribution of loads from a proxy server upon said proxy server becoming overutilized.

27. The method of claim 25 further comprising communicating a consolidation message from a proxy server requesting consolidation of loads upon said proxy server becoming underutilized.

28. The method of claim 24 further comprising determining at a proxy server receiving a join request the load status of such proxy server; determining whether there is a more optimum neighboring proxy to accept the request; and admitting the request upon determining there is no other optimum proxy for accepting the request.

29. The method of claim 28 further comprising checking, upon receiving the join request, whether a loop is created, and, upon determining that a loop is created, redirecting the request to another proxy.

30. The method of claim 28 further comprising determining the status of said proxy server receiving said join request, and, upon determining that accepting such request will cause overutilization of such proxy server, executing a process to determine whether redistributing a portion of the load of such proxy server will enable such proxy server to admit the join request, and upon determining that redistribution of a portion of the load is possible, redistributing said portion of said load and admitting the join request.

31. The method of claim 30 further comprising, upon determining redistribution of a portion of said load is not possible, determining whether there is another suitable proxy and redirecting the join request to such suitable proxy, otherwise denying said request.

32. The method of claim 24 wherein said predetermined relationship comprises a relationship between tension and loading.

33. The method of claim 32, wherein said optimum utilization of network resources comprises loading said network resources at a level which produces a minimum tension.
